(19) United States
(12) Patent Application Publication
(10) Pub. No.: US 2018/0125292 A1
(43) Pub. Date: May 10, 2018

(54) DUTCH OVEN

(71) Applicant: Barebones Systems, LLC, Salt Lake City, UT (US)

(72) Inventors: Robert Emmett Workman, Morgan, UT (US); Henry Howell, Herriman, UT (US); Kristin Mecham, Springville, UT (US); Michelle Ann Merrill, Draper, UT (US); David Jared Burton, Payson, UT (US); Erik Robert Workman, Salt Lake City, UT (US)

(21) Appl. No.: 15/667,591

(22) Filed: Aug. 2, 2017

Related U.S. Application Data
(60) Provisional application No. 62/370,224, filed on Aug. 2, 2016.

(51) Int. Cl. A47J 37/06; A47J 36/06

(52) U.S. Cl. CPC A47J 37/0623; A47J 36/06

(57) ABSTRACT

A cast iron Dutch oven comprising a pot having a generally planar base portion, an upwardly extending and outwardly tapered wall portion integrally formed with the base portion, the base portion defining a top edge having a plurality of raised portions separated by a plurality of lowered portions, and a plurality of wide legs having a crescent shape disposed around a perimeter of the base portion. A lid has a raised top wall around a top perimeter and a bottom edge contoured to mate with the top edge of the pot with corresponding raised portions separated by corresponding lowered portions. A plurality of downwardly extending flanges extend into the pot when the lid is positioned on the pot to prevent the lid from sliding from the pot and to create vent openings when the lid is rotated relative to the pot.

### CROSS-REFERENCE TO RELATED APPLICATION

The present application claims priority to U.S. Provisional Patent Application Ser. No. 62/370,224 filed on Aug. 2, 2016, the entirety of which is incorporated by this reference.

### BACKGROUND

### Field of the Invention

The present invention relates generally to cookware and more specifically to Dutch ovens, cooking pots and the like.

### State of the Related Art

Cast iron Dutch ovens and cooking pots have been available for decades. Such Dutch ovens are typically formed from pig iron, recycled cast iron and/or scrap steel that is melted into molten cast iron. Vermiculite is often added as a bonding agent to remove impurities. The molten cast iron is then poured into a sand mold. Once sufficiently cooled, the cookware is shaken and tumbled to remove the sand mold and then shot blasted to remove any remaining sand particles. The cookware is then ground, polished, rinsed and dried. Oil is then applied to the cookware and the cookware is placed in an oven to season the cookware giving it its black color and inhibiting rust. Such prior art cookware and specifically Dutch ovens typically have relative short stubby legs and a flat top rim and corresponding flat lid. There exists a need in the art, however, to provide a cast iron Dutch oven that includes wider and taller legs to provide more stability on uneven surfaces or on cooking grates and that has a lid that allows for venting.

### SUMMARY OF THE INVENTION

Accordingly, the present invention provides an improved cast iron Dutch oven that includes a pot with legs and a corresponding lid. The legs are wide and provide a more stable support for the pot. In addition, the legs allow for easy placement and removal of briquettes from beneath the pot. The top edge of the pot is wavy to match a corresponding wavy shape in the bottom edge of the lid. In one position, the lid and pot mate to seal the lid to the top of the pot. Rotating the lid relative to the pot, however, causes the lid and pot to misalign, thus creating vent openings between the top of the pot and the bottom of the lid.

In one embodiment, a cast iron Dutch oven according to the present invention comprises a pot having a generally planar base portion and an upward and outwardly extending, generally frustoconical wall portion integrally formed with the base portion. The base portion defines a top edge having a plurality of raised portions separated by a plurality of lower portions. A plurality of legs having a crescent shape are disposed around a perimeter of the base portion. A lid has a raised top wall extending around a top perimeter of the lid. The bottom edge of the lid is contoured to mate with a top edge of the pot with a corresponding plurality of raised portions separated by a corresponding plurality of lower portions, and a plurality of downwardly extending flanges inset from the bottom edge, the plurality of downwardly extending flanges extending into the pot when the lid is positioned on the pot to prevent the lid from sliding from the pot without lifting and to create a vent opening when the lid is rotated relative to the pot when the bottom edge of the lid is resting upon the top edge of the pot.

In one embodiment, a handle is coupled to a pair of outwardly extending flanges integrally formed with the lid. The pair of outwardly extending flanges include at least one aperture for receiving first and second circular ends of the handle.

In another embodiment, the handle spans the width of the pot and has a curved shape to be able to rest on either side of the pot when not in a lifted position. The handle is comprised of an elongate section of a wire rod bent at its ends to attach to the pair of flanges and further comprises a grasping portion formed of wire wound around the elongate section of wire. The grasping portion is positioned at a midpoint between the ends of the handle. The elongate section of wire includes an upwardly bent portion at its midpoint to retain the grasping portion at a center of the handle.

In yet another embodiment, an effective radius of the handle is greater than the outer radius of the lid so that in a resting position, the grasping portion is held away from the lid and pot so that the grasping portion will not conduct heat directly from the lid or pot by direct contact.

In another embodiment, the flange portions abut against the handle when the handle is rotated to a resting position.

In still another embodiment, the lid includes an upwardly extending outer wall so that briquettes for heating the lid and thus the contents of the of the pot are prevented from falling from the lid.

In another embodiment, the plurality of legs comprises three legs that depend downwardly from and are integrally formed with an outer perimeter of a bottom of the pot. Each leg has a curved contour to match an outer contour of the pot and has a bottom width of about 10-15 percent of the total circumference of a base of the pot.

In still another embodiment, when the lid is rotated relative to the pot the lower portions of the lid at least partially align with the and rest upon the raised portions of the pot, thus creating an air gap between the raised portions of the lid and the lower portions of the pot.

In yet another embodiment, the lid includes a plurality of downwardly extending flanges that hold the lid to the pot by extending into an interior of the pot proximate the wall portion.

In still another embodiment, the flanges prevent the lid from being slid off of the pot without first lifting the lid relative to the pot.

In another embodiment, when the lid is rotated relative to the pot to misalign the contour between the top edge of the pot and the lower edge of the lid, the flanges control a width of the air gap between the lid and the pot.

In yet another embodiment, as the lid is rotated relative to the pot, the plurality of flanges keep the air gaps closed at locations of the plurality of flanges and when the plurality of flanges are positioned opposite the raised portions of the pot, the corresponding air gaps are in a fully open position.

In another embodiment, when each of the plurality of flanges is rotated back toward a lower portion of the pot, the air gap is partially closed until the lid is reseated with the pot.

In yet another embodiment, an underside of the lid includes a charcoal briquette temperature guide cast therein.

These and other aspects of the present invention may be realized in an improved Dutch oven as shown and described in the following figures and related description.

### BRIEF DESCRIPTION OF THE DRAWINGS

When considered in connection with the following illustrative figures, a more complete understanding of the present invention may be derived by referring to the detailed description. In the figures, like reference numbers refer to like elements or acts throughout the figures. Various embodiments of the present invention are shown and described in reference to the numbered drawings.

FIG. 1 is a perspective top side view of a Dutch oven in accordance with the principles of the present invention;

FIG. 2 is a first side view of the Dutch oven shown in FIG. 1;

FIG. 3 is a second side view of the Dutch oven shown in FIG. 1;

FIG. 4 is a perspective cross-sectional side view of the Dutch oven shown in FIG. 1;

FIG. 5 is a cross-sectional bottom view of the Dutch oven shown in FIG. 1;

FIG. 6 is a third side view of the Dutch oven shown in FIG. 1;

FIG. 7 is a first cross-sectional side view of the Dutch oven shown in FIG. 1; and

FIG. 8 is a second cross-sectional side view of the Dutch oven shown in FIG. 1.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. Elements and acts in the figures are illustrated for simplicity and have not necessarily been rendered according to any particular sequence or embodiment.

### DETAILED DESCRIPTION OF THE ILLUSTRATED EMBODIMENTS

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors fully informed of the standards and application of the special provisions of 35 U.S.C. § 112, ¶6. Thus, the use of the words “function,” “means” or “step” in the Detailed Description of the Invention or claims is not intended to somehow indicate a desire to invoke the special provisions of 35 U.S.C. § 112, ¶ 6, to define the invention. To the contrary, if the provisions of 35 U.S.C. § 112, ¶ 6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. § 112, ¶ 6. Moreover, even if the provisions of 35 U.S.C. § 112, ¶ 6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. Thus, the full scope of the inventions is not limited to the examples that are described below.

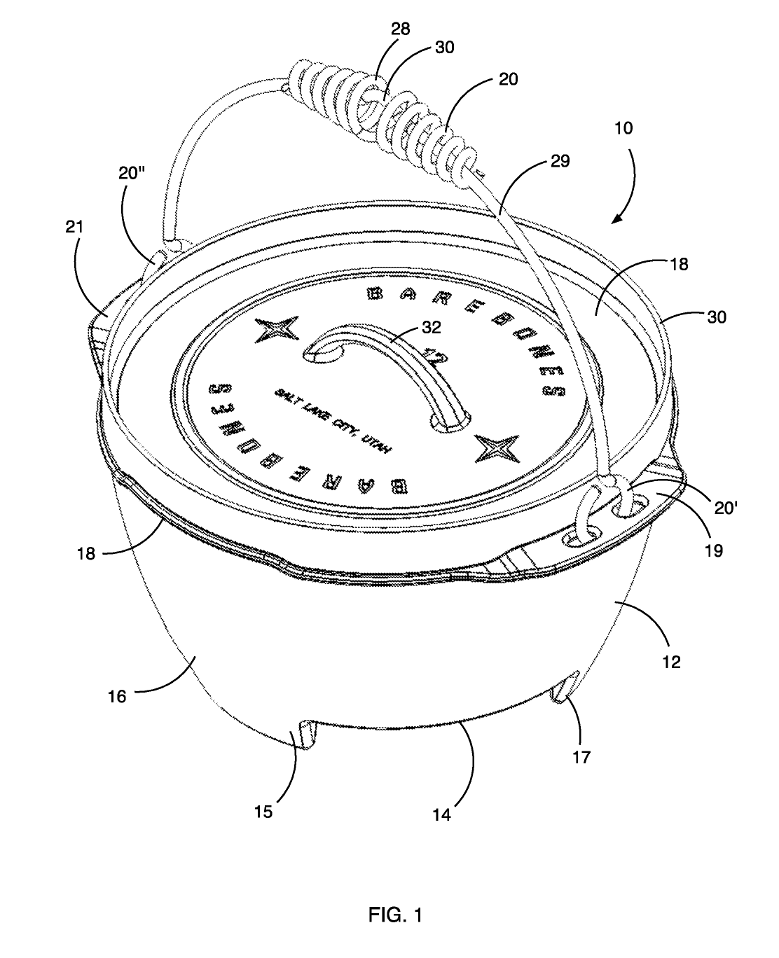

FIG. 1 illustrates a Dutch oven, generally indicated at 10, in accordance with the principles of the present invention. The Dutch oven 10 includes a pot 12 with three integral legs, two of which legs 15 and 17 are visible, a lid 18 and a handle 20 coupled to the pot 12. The pot 12 is comprised of a generally planar and generally circular bottom portion 14 and an outwardly tapered and generally circular side wall 16 depending from an outer circumferential area of the bottom portion 14. That is the side wall 16 is generally frustoconical in shape, although it may have a slight curvature from top to bottom, and depends from the bottom portion 14 at an angle of about 75 degrees, plus or minus about 10 degrees. The Dutch oven may come in various sizes, which are typically measured by the diameter of the top edge 18 of the side wall 16 of the Dutch oven 10, such as for example, and not by way of limitation, 16 inches, 14 inches, 12 inches, 10 inches or 8 inches.

A handle 20 is coupled to outwardly extending flanges 19 and 21, each with a pair of apertures for receiving circular ends 20′ and 20″ of the handle 20. That is. the ends 20′ and 20″ of the handle 20 loop through the apertures in the flanges 19 and 21, respectively. The handle 20 thus spans the width of the pot 12 and has a curved shape to be able to rest on either side of the pot 12 when not in a lifted position as shown. The handle 20 is comprised of an elongate section of a wire rod or thick wire that is bent at its ends to form the ends 20′ and 22″. In addition, the handle includes a grasping portion 28 formed of wire wound around the elongate section of wire and is positioned at a midpoint between the ends 20′ and 22″. The elongate section of wire includes an upwardly bent portion 30 at its midpoint to retain the grasping portion 28 at the center of the handle 20. The windings of the grasping portion 28 are spaced around the bent portion 30 so as to be held relative thereto due to the bend in the wire 29.

The effective radius of the handle 20 is slightly greater than the outer radius of the lid 18 so that in a resting position, the wound grasping portion 28 is held away from the sides of the lid 18 and pot 12 so that the grasping portion will not conduct heat directly from the lid 18 or pot 12 by direct contact. The flange portions 19 and 21 abut against the wire 29 when the handle is rotated to a resting position and thus hold the handle 20 away from the lid 18 and pot 12. Also, the flanges 19 and 21 form an abutment surface for the handle so that the handle can rotate only about 180 degrees from side to side relative to the flanges 19 and 21.

The lid 18 includes an upwardly extending outer wall 30 so that briquettes for heating the lid and thus the contents of the Dutch oven 10 are prevented from falling from the lid 18. That is, during cooking, briquettes are stacked on top of the lid 18 and lit to provide heat for cooking. During cooking, however, it is often necessary to examine the contents by lifting the handle 32 of the lid 18. The wall 30 helps to hold the briquettes on top of the lid 18 during such movement of the lid 18. The handle 32 will become hot due to hot briquettes being placed on top of the lid 18, so it is often the case that various lid removal devices such as hooks or gloves are used to lift the lid 18 without the user having to directly touch the handle 32.

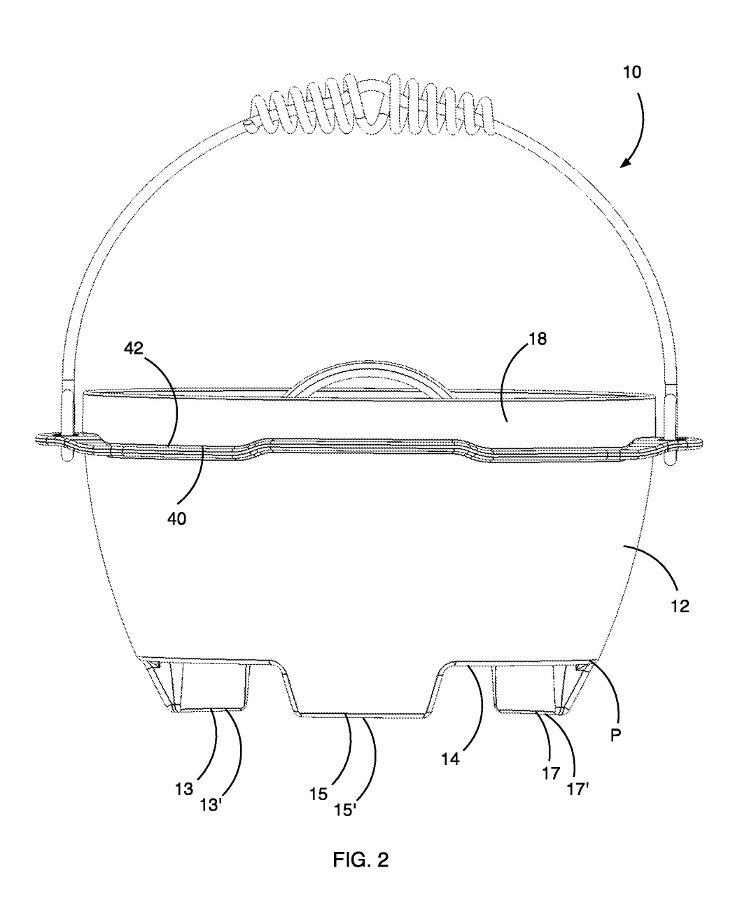

As shown in FIG. 2, the pot 12 includes three legs 13, 15 and 17 that depend downwardly from and are integrally formed with the outer perimeter of the bottom 14 of the pot 12. Each leg 13, 15 and 17 has a curved contour to match the outer contour of the pot and have a bottom width of about 10-15 percent of the total circumference of the base 14. That way, the legs have sufficient width to support the pot 12 on uneven surfaces or on cooking grates, but define openings between the legs 13, 15 and 17 for access to the space created beneath the pot 12. This allows for the addition, removal or stoking of briquettes underneath the pot 12. Prior art Dutch ovens typically have three small circular legs that extend from the bottom of the pot. Such small legs are often unstable on uneven surfaces, are difficult to use on cooking grates and thus do not provide great stability for the pot. In the present invention, the bottom surfaces 13′ 15′ and 17′ of the legs 13, 15 and 17, respectively, extend around the bottom perimeter P of the pot 12 between 30 and 45 percent of the total perimeter P circumference. Thus, the spaces defined between each leg 13, 15 and 17 comprise about 70 to 55 percent of the total perimeter P circumference. In addition, the legs 13, 15 and 17 have a height H from the bottom 14 of the pot 14 sufficient to allow briquettes to be placed and removed from under the pot 12 during cooking to add heat to the bottom of the pot 12 as well during cooking. Thus, the height of the legs 13, 15 and 17 may be from about 1 inch to 3 inches tall. This wide, tri-leg design provides superior stability and functionality over prior art Dutch ovens by providing a wide support base as well as allowing bottom heating of the pot 12.

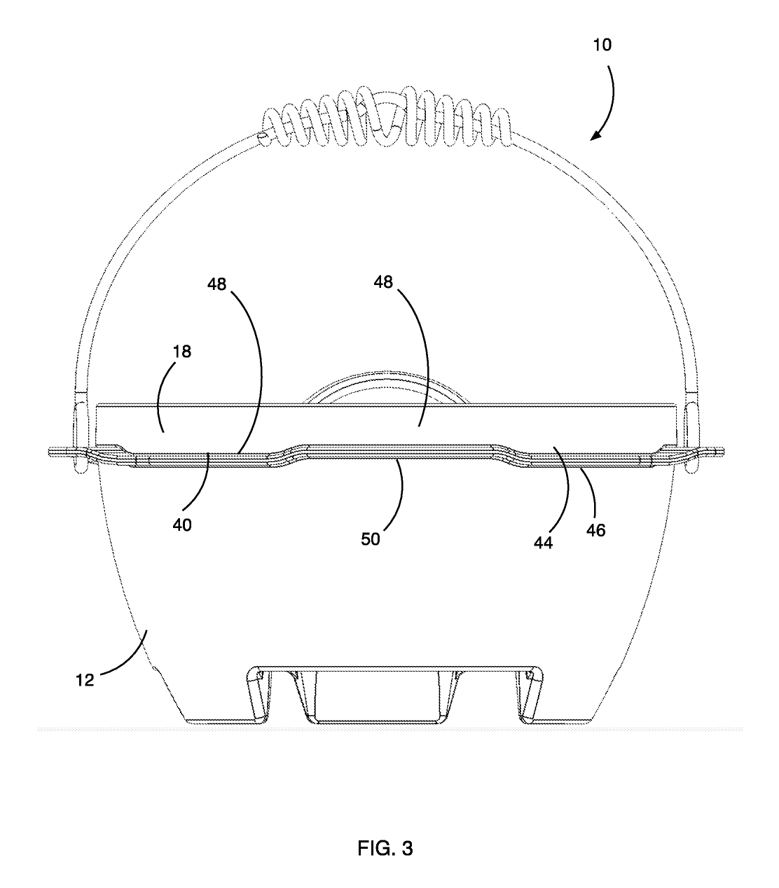

As further shown in FIGS. 2 and 3, the bottom edge 40 of the lid 18 and the top edge 42 of the pot 12 have a wavy pattern, with corresponding and mating higher and lower portions. That is the lower portions 44 of the lid 18 mate with corresponding lower portions 46 of the pot 12 and the higher portions 48 of the lid 18 mate with the higher portions 50 of the pot 12. When the lid 18 is rotated relative to the pot 12, however, the lower portions 44 of the lid 18 at least partially align with the and rest upon the higher portions 50 of the pot 12, thus creating an air gap or vent between the higher portions 48 of the lid 18 and the lower portions 46 of the pot 12.

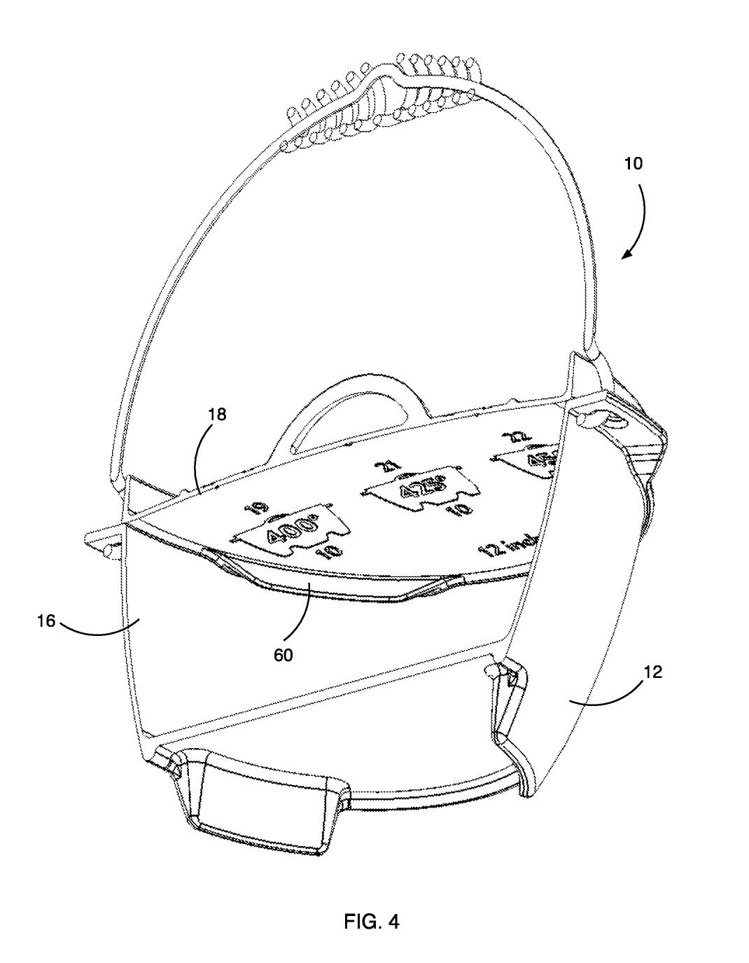

As further show in the cross-section in FIG. 4, the lid 18 includes a plurality of downwardly extending flanges 60 that serve two purposes. First, the flanges 60 hold the lid 18 to the pot 12 by extending into the interior of the pot 12 proximate the side wall 16. Because there are a plurality of such flanges 60 around the perimeter of the lid 18, the flanges 60 prevent the lid 18 from being slid off of the pot 12 without first lifting the lid 18. Second, when the lid is rotated relative to the pot 12 as previously described to misalign the contour between the top edge 42 of the pot 12 and the lower edge 40 of the lid 18, the flanges 60 control the width of the air gap between the lid 18 and the pot 12. That is, as shown, each flange 60 is aligned with and has the same general contour as the lower portion, such as lower portion 44 from which it depends. As the lid 18 is rotated, the flange 60 keeps the opening closed at the location of the flange 60. When the flange 60 is positioned opposite a raised portion 50 of the pot 12, the air gap or vent is in a fully open position. When the flange 60 is rotated back toward a lower portion 46 of the pot 12, the air gap is thus partially closed accordingly until the lid 18 is reseated with the pot 12 as shown in FIG. 3. Thus, by simple rotation of the lid 18 relative to the pot 12, heat and/or steam from food being cooked can be vented as desired without having to cock the lid 18 relative to the pot 12, as is currently the prior art method with prior art Dutch ovens. Cocking the lid 18 can allow ash from the briquettes to enter the inside of the pot 12, which is highly undesirable. With the Dutch oven of the present invention, vent openings can be created without having to remove the lid 18 from the pot 12 that can also disturb any briquettes and briquette ash thereon.

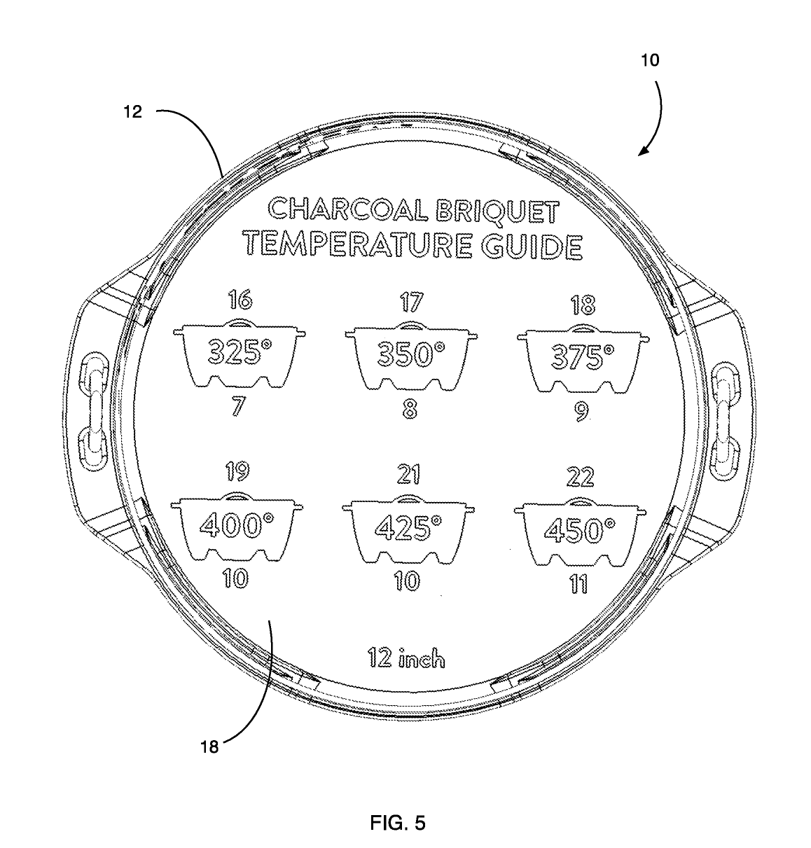

Referring now to FIG. 5, a cross-sectional bottom view of the Dutch oven 10 is shown to illustrate the bottom surface 70 of the lid 18. Cast into the bottom surface 70 is a charcoal briquette temperature guide. The temperature guide includes several illustrations of a Dutch oven with a temperature on the Dutch oven illustration. The temperature guide is specific to the particular size of the Dutch oven. In this case, the temperature guide is for a 12 inch Dutch oven in order to obtain the desired cooking temperature. For example, to reach a temperature of 325 degrees Fahrenheit, 16 charcoal briquettes should be placed on the lid 18 of the Dutch oven 10 and 7 charcoal briquettes should be placed under the pot 12 of the Dutch oven 10. To reach a temperature of 450 degrees Fahrenheit, 22 charcoal briquettes should be placed on the lid 18 of the Dutch oven 10 and 11 charcoal briquettes should be placed under the pot 12 of the Dutch oven 10. Other temperatures can be maintained by following the temperature guide. By having the temperature guide permanently cast into the bottom of the lid 18 with raised or recessed lettering, the user will always have access to the proper amount and placement of charcoal briquettes when cooking with the Dutch oven 10 of the present invention.

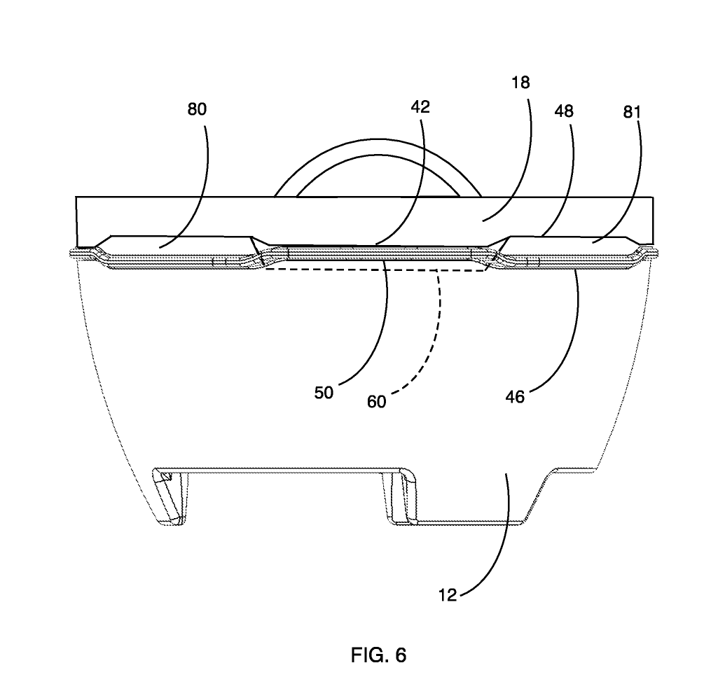

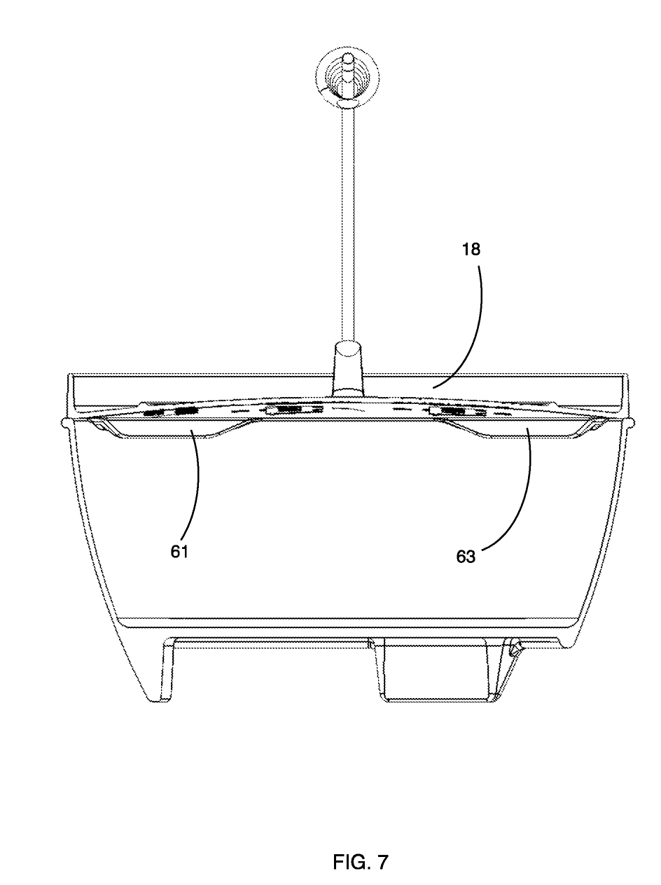

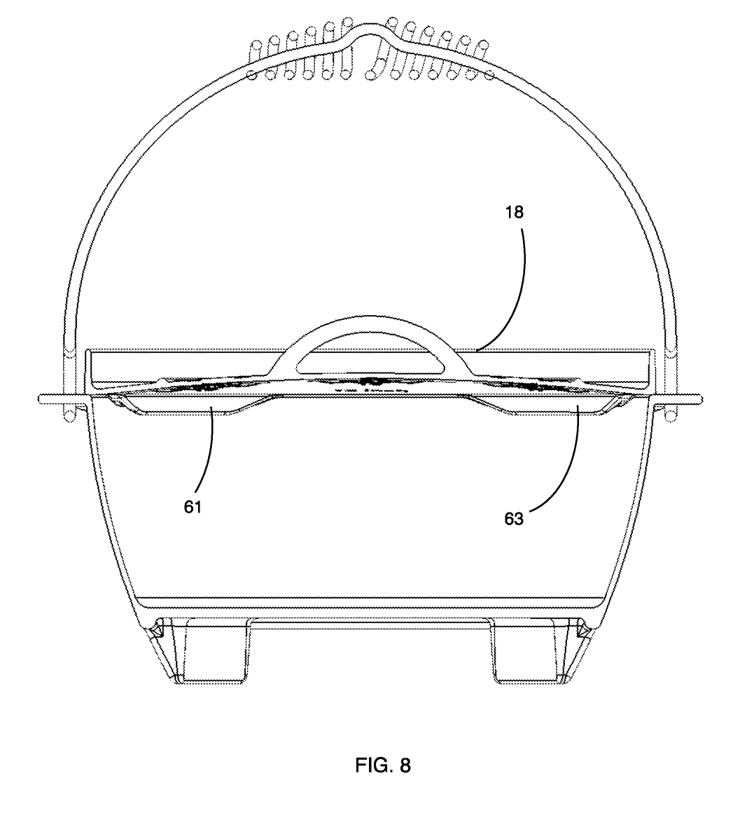

FIG. 6 illustrates a side view of the Dutch oven 10 of the present invention where the lid 18 has been rotated relative to the pot 12 such that vent holes 80 and 81 are formed between the lid 18 and the pot 12. In this position, the inner flange, such as inner flange 60 (see also FIG. 4), resides behind the lower portion 42 to prevent the lid 18 from becoming dislodged from the pot 12 as the lid 18 is rotated relative to the pot 12. The air gap 81 that is formed between the lower portion 46 of the lid and the higher portion 48 of the rim of the lid 18 can be further controlled by continuation to rotate the lid 18 relative to the pot 12 so that the flange 60 begins to partially close the vent 81. As shown in FIGS. 7 and 8, similar flanges 61 and 63 to flange 60 are evenly spaced around the inner perimeter of the lid 18 and are provided behind each lower portion of the lid to coordinate with each similarly configured lower rim portion of the lid. The flanges 60, 61 and 63 extend down further from the top of the lid than the lower portions of the lid so as to be able to retain the lid on the pot 12 when the lid is rotated relative to the pot 12.

There is thus disclosed an improved Dutch oven and method of using the improved Dutch oven. In the foregoing specification, the present invention has been described with reference to specific exemplary embodiments. Various modifications and changes may be made, however, without departing from the spirit and scope of the present invention as set forth in the claims, including combinations of elements of the various illustrated embodiments. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The phrase “consisting essentially of” as used herein is intended to cover additional elements or functions that do not materially affect the basic and novel characteristics of the claimed invention. Thus, “consisting essentially of” is intended to encompass not only those components specifically listed, but also separate or additional components that do not materially alter the specifically recited functions or elements.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A cast iron Dutch oven, comprising:
a pot comprising:
a generally planar base portion;
an upward and outwardly extending, generally frustoconical wall portion integrally formed with the base portion, the base portion defining a top edge having a plurality of raised portions separated by a plurality of lower portions; and
a plurality of legs having a crescent shape disposed around a perimeter of the base portion; and
a lid having a raised top wall extending around a top perimeter of the lid, a bottom edge contoured to mate with the top edge of the pot with a corresponding plurality of raised portions separated by a corresponding plurality of lower portions, and a plurality of downwardly extending flanges inset from the bottom edge, the plurality of downwardly extending flanges extending into the pot when the lid is positioned on the pot to prevent the lid from sliding from the pot without lifting and to create a vent opening when the lid is rotated relative to the pot when the bottom edge of the lid is resting upon the top edge of the pot.

2. The cast iron Dutch oven of claim 1, further comprising a handle coupled to a pair of outwardly extending flanges integrally formed with the lid, the pair of outwardly extending flanges including at least one aperture for receiving first and second circular ends of the handle.

3. The cast iron Dutch oven of claim 2, wherein the handle spans the width of the pot and has a curved shape to be able to rest on either side of the pot when not in a lifted position, the handle is comprised of an elongate section of a wire rod bent at its ends to attach to the pair of flanges and further comprising a grasping portion formed of wire wound around the elongate section of wire and is positioned at a midpoint between the ends of the handle, the elongate section of wire including an upwardly bent portion at its midpoint to retain the grasping portion at a center of the handle.

4. The cast iron Dutch oven of claim 3, wherein an effective radius of the handle is greater than the outer radius of the lid so that in a resting position, the grasping portion is held away from the lid and pot so that the grasping portion will not conduct heat directly from the lid or pot by direct contact.

5. The cast iron Dutch oven of claim 4, wherein the flange portions abut against the handle when the handle is rotated to a resting position.

6. The cast iron Dutch oven of claim 1, wherein the lid includes an upwardly extending outer wall so that briquettes for heating the lid and thus the contents of the of the pot are prevented from falling from the lid.

7. The cast iron Dutch oven of claim 1, wherein the plurality of legs comprises three legs that depend downwardly from and are integrally formed with an outer perimeter of a bottom of the pot, each leg having a curved contour to match an outer contour of the pot and have a bottom width of about 10-15 percent of the total circumference of a base of the pot.

8. The cast iron Dutch oven of claim 1, wherein when the lid is rotated relative to the pot the lower portions of the lid at least partially align with the and rest upon the raised portions of the pot, thus creating an air gap between the raised portions of the lid and the lower portions of the pot.

9. The cast iron Dutch oven of claim 1, wherein the lid includes a plurality of downwardly extending flanges that hold the lid to the pot by extending into an interior of the pot proximate the wall portion.

10. The cast iron Dutch oven of claim 9, wherein the flanges prevent the lid from being slid off of the pot without first lifting the lid relative to the pot.

11. The cast iron Dutch oven of claim 10, wherein when the lid is rotated relative to the pot to misalign the contour between the top edge of the pot and the lower edge of the lid, the flanges control a width of the air gap between the lid and the pot.

12. The cast iron Dutch oven of claim 11, wherein as the lid is rotated relative to the pot, the plurality of flanges keep the air gaps closed at locations of the plurality of flanges and when the plurality of flanges are positioned opposite the raised portions of the pot, the corresponding air gaps are in a fully open position.

13. The cast iron Dutch oven of claim 12, wherein when each of the plurality of flanges is rotated back toward a lower portion of the pot, the air gap is partially closed until the lid is reseated with the pot.

14. The cast iron Dutch oven of claim 1, wherein an underside of the lid includes a charcoal briquette temperature guide cast therein.
